(19) United States
(12) Patent Application Publication
(10) Pub. No.: US 2013/0042979 A1
(43) Pub. Date: Feb. 21, 2013

(54) Laminator

(71) Applicant: Bernd Loibl, Klettgau (DE)

(72) Inventor: Bernd Loibl, Klettgau (DE)

(21) Appl. No.: 13/372,655

(22) Filed: Feb. 14, 2012

(30) Foreign Application Priority Data
Mar. 25, 2011 (DE) 20 2011 004 428.9

(51) Int. Cl. B32B 37/06

(52) U.S. Cl. 156/583.1

(57) ABSTRACT

A laminator for hot laminating sheet material and a laminating foil, comprising a unit housing through which a pass-through channel extends for passing through a combination of a sheet material and a laminating foil, wherein at least one laminating unit including a pair of opposite laminating rollers defining a laminating gap is arranged in the pass-through channel, wherein a heating rod extends along at least one of the two laminating rollers forming the pair, wherein the heating rod is connected to an electric power supply and configured as a PTC heating rod, wherein the PTC heating rod is associated with a timing switch for power supply which divides the power supply in an alternating manner into time intervals without power being supplied and time intervals with power being supplied.

### RELATED APPLICATIONS

This application claims priority from and incorporates by reference German patent application 20 2011 004 428.9, filed on Mar. 25, 2011.

### FIELD OF THE INVENTION

The invention relates to a laminator for hot laminating sheet material and laminating foil including a unit housing through which a pass-through channel extends for passing through a combination of sheet material and laminating foil, in which at least one laminating unit with a pair of opposite rollers is arranged which define a laminating gap, wherein a heating rod, which is configured as a PTC (Positive Temperature Coefficient) heating rod, extends along at least one of the two laminating rollers forming the pair.

### BACKGROUND OF THE INVENTION

In order to protect sheet material in particular valuable documents it is known to weld the sheet material into a laminating foil. Thus, the sheet material is placed between two foil sheets forming a laminating foil, wherein the foil sheets and the sheet material are then jointly transported through the laminating unit. The foil sheets can also be provided in a laminating foil pouch, wherein the two foil sheets are connected with one another at least at one side edge. Such laminating foils are known, for example, from DE 201 00 328 U1. It is characteristic for laminating foils that they are configured as composite foils in which a transparent, clear foil, for example, made from polyester or polypropylene, is internally provided with a heat sensitive glue layer which is made, for example, from EVA (ethylene-vinylacetat-copolymer).

In the non-industrial field, this means for business and personal applications, laminators are typically being used that are configured as table units. Laminators of this type are known, for example, from DE 20 2009 000903 U1. They have essentially similar configurations, this means a unit housing in which a laminating unit is arranged. Between a feed opening on one side and an exit opening on another side of the unit housing, a pass-through channel extends, wherein the laminating unit is associated with the pass-through channel. The laminating unit typically includes a roller pair, sometimes also plural roller pairs, which respectively include two laminating rollers arranged on top of one another and forming a laminating gap. Thus, the laminating gap is adjusted so that the combination of sheet material and laminating foil in the laminating gap is exposed to a substantial pressure.

In hot laminators, at least one of the laminating rollers, typically both laminating rollers are heated. When passing a combination of sheet material and laminating foil through, the combination is additionally heated in the laminating gap. This activates the glue layer of the laminating foil and provides an interconnection of the foil sheets with one another and with the sheet material to be encased through welding. Thus the temperature for hot laminating is adjusted so that the edge portion of the foil sheets which includes the clear foil without sheet material is not degraded through the heat impact.

For heating the laminating rollers, typically heating rods are being used which extend along at least one of the laminating rollers forming the pair. Typically, the laminating rollers are externally heated (c.f. DE 100 04 486 A1). The heating rods, however, can also be installed into laminating rollers that are configured as hollow rollers. This, however, has the disadvantage that electric power has to be transmitted through slip contacts which do not only generate losses but also require spark protection devices.

Typically normal resistive heating rods are being used for heating rods. Thus, the heating phase is acceptably short, however such heating rods have a power input which would cause excessively high temperatures later on without additional control. Thus, in view of the heat resistance of the laminating foil, it is desirable to keep the temperature of the laminating rollers in a temperature range between 110° C. and 130° C. This object can be achieved by providing a timing switch for the power supply which divides the power supply in an alternating manner, this means in an intermittent manner into time intervals without power supply and time intervals with power supply. In view of the high power consumption during the phase in which power is supplied, only a very uneven temperature profile with temperature variations in excess of 30° C. can be achieved. Additionally, there is a tendency that the temperature increases more and more over time in spite of the frequent power interruptions. In order to prevent damages to the laminator, therefore an additional overheat protection is required. When the overheat protection is activated, the laminator is not available during the cooling time. Therefore, it has also been attempted to provide a complex temperature regulation. Even in this case, high power consumption remains. Furthermore, the housing of the laminator has to be made from a highly temperature resistant plastic material. Such plastic materials are difficult to dispose of.

Additionally, it has been attempted to heat the laminating rollers through PTC heating rods. These have temperature-resistance properties which makes the generated heat output decrease with increasing temperature, this means the PTC heating rod is substantially self-regulating. In such PTC heating rods, external control or regulation and overheating protection are typically omitted. Another advantage is that laminating foils with different thicknesses can be laminated with the same temperature since the PTC heating rod regulates the heat energy according to the heat requirement, this means for a thinner foil less heat energy is provided than for a thicker foil.

However, it has become apparent that the temperature properties of PTC heating rods for applications in laminators is not optimized yet, in particular when the laminator remains turned off over a longer period of time.

### BRIEF SUMMARY OF THE INVENTION

Thus it is the object of the invention to configure a laminator so that the heat generation in the laminator remains constant over a long period of time so that the laminating results are independent from the time period during which the laminator is turned on.

This object is achieved according to the invention in that a timing switch for power supply is associated with the PTC heating rod, wherein the timing switch divides the power supply in an alternating manner into time intervals without power supply and time intervals with power supply. Thus, the basic idea of the invention is to associate the PTC heating rod in spite of its self regulating temperature properties with a timing switch for intermitting the power supply. Surprisingly it has become apparent that this yields a very even temperature curve with very small variations and with substantially unlimited long term stability. Therefore no additional temperature regulation and no overheat protection are required and a relatively short heat up time can be provided. Additionally, power consumption is significantly reduced over regular heating rods and still significantly reduced over PTC heating rods without timing control. The intermittent power supply facilitates setting a temperature that is optimum for the laminating results so that the laminating results also remain constant in a reproducible manner. Eventually, using highly temperature-resistant plastic materials is not required anymore.

In one embodiment of the invention it is provided that the time intervals without power supply and the time intervals with power supply are constant so that the power supply is interrupted in constant time intervals.

The ratio of the time intervals with and without power supply that is optimal for the respective laminator can be determined through a reasonable number of simple experiments. In most cases, the time intervals with power supply can be shorter than the time intervals without power supply which reduces power consumption accordingly. For example the length of the time intervals without power supply can correspond to three times, advantageously at least four times the length of the time intervals with supply. Advantageously the length of the time intervals with power supply is below ten seconds, advantageously below five seconds.

Advantageously, the nominal temperature of the laminator, thus the temperature which is reached after the heat up phase is between 110° C. and 130° C., advantageously between 115° C. and 125° C., even more advantageously at 120° C. Then the lengths of the time intervals with and without power supply should be adjusted so that the nominal temperature is maintained with a variation ±2° C. These settings can be empirically determined in a simple manner through the experiments recited supra.

In another embodiment of the invention it is provided that the timing switch only becomes effective after a heat up phase after starting the laminator, thus only when the PTC heating rod has reached the nominal temperature of the laminator. Thus, the heat up phase should take at least two minutes, advantageously at least four minutes.

According to the invention it is furthermore provided that the PTC heating rod axially extends through at least one of the laminating rollers forming the pair, so that the respective laminating roller is internally heated. This provides effective heating for the laminating rollers. Advantageously, the PTC heating rod should be fixated at the unit, wherein the respectively associated laminating roller is rotatably supported relative to the PTC heating rod. Due to the fixation at the unit, the PTC heating rod can be directly connected with electrical power supply cables. The disadvantages of a slip ring power supply are therefore obviated.

In another embodiment of the invention it is provided that the PTC heating rod is made from ceramic material with barium-nitrate as a base material. The heating rod should be provided on both sides with flat electrodes extending over the length of the heating rods.

Since there is no heat conducting connection between the PTC heating rod and the laminating rollers, the heat transfer is not as good as when the heating rod is fixated in the laminating roller. However, good heat transfer values are achieved when the distance to the PTC heating rod is as small as possible, advantageously 0.5 to 1 mm.

The advantages of the invention are already achieved when only one of the laminating rollers forming the pair is provided with a PTC heating rod according to the invention. Advantageously, however, both laminating rollers are configured so that each laminating roller is provided with a PTC heating rod fixated at the unit. It is appreciated, however, that also plural pairs of laminating rollers can be provided which are configured with PTC heating rods in the same manner.

### BRIEF DESCRIPTION OF THE DRAWINGS

The invention is illustrated in more detail with reference to drawing figures, wherein:

FIG. 1 illustrates a perspective view of the backside of the laminator according to the invention;

FIG. 2 illustrates the laminator according to FIG. 1 in a sectional view;

FIG. 3 illustrates a perspective view of a laminating roller of the laminator according to FIGS. 1 and 2 with a PTC heating rod;

FIG. 4 illustrates a lateral face view of the laminating roller according to FIG. 3;

FIG. 5 illustrates a longitudinal sectional view of the laminating roller according to FIGS. 3 and 4;

FIG. 6 illustrates a diagram representing the power consumption of the PTC heating rod over time compared to a normal resistive heating rod; and

FIG. 7 illustrates a diagram representing the temperature of the PTC heating rod over time after starting the laminator compared to the temperature diagram of the regular resistive heating rod.

### DETAILED DESCRIPTION OF THE INVENTION

The laminator 1 illustrated in the drawing figure includes a housing 2 with a flat housing base 3, a front wall 4 and a rear wall 5, and a curved upper wall 6 connecting the front wall 4 and the rear wall 5. The upper wall 6 is provided with a plurality of cooling slots 7.

A downward slanted pass-through channel 8 extends from the rear wall 5 to the front wall 4 through the housing 2, wherein the pass-through channel has a width so that A4 sheet material can be passed through sideways. The pass-through channel 8 is defined on the input side through a feed opening 9 in the rear wall 5 at an exit opening 10 in the front wall 4.

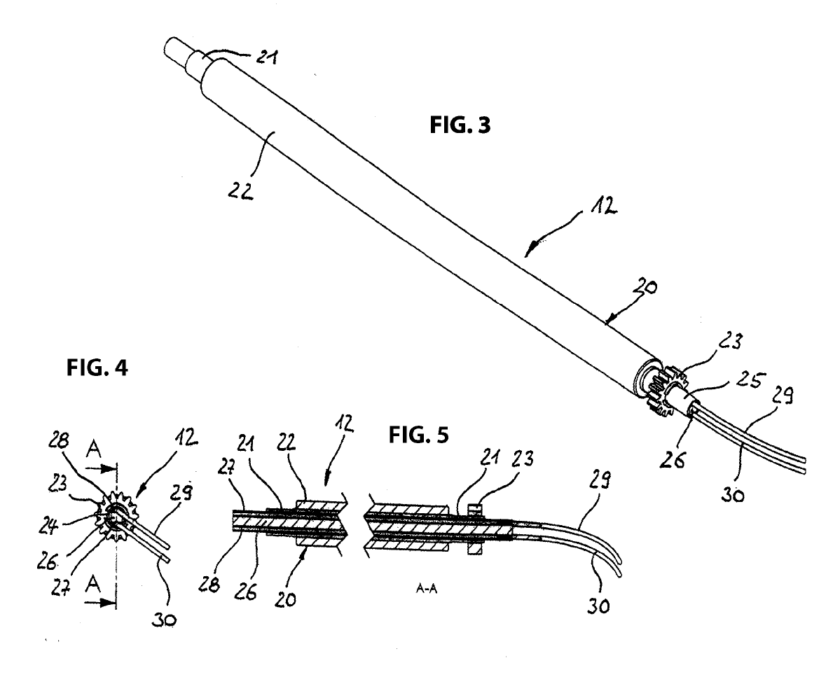

Approximately in the center of the pass-through channel 8, there is a laminating unit 11 of which two laminating rollers 12, 13 are illustrated which are arranged on top of one another with their rotation axes arranged parallel to one another. The laminating rollers 12, 13 extend over the entire width of the pass-through channel 8 and form a laminating gap 14 between one another. The laminating rollers 12, 13 are heated which is illustrated in more detail in FIGS. 3 through 5. The laminating rollers are also part of a transport device which includes a drive with an electric motor which is not illustrated herein in more detail, wherein the drive synchronously drives the two laminating rollers 12, 13 during the laminating process, thus the upper laminating roller 12 clockwise and the lower laminating roller 13 counterclockwise. Their circumferential speeds are identical.

A sheet support 15 is attached at the rear wall 5, wherein a top side 16 of the sheet support is flush with a bottom side of the pass-through channel 8 and inclined with the same orientation as the pass-through channel 8 itself. Adjacent to the supply opening 9, two support bars 17, 18 protrude beyond the top side 16 of the sheet support 15, wherein the opposing support bars are movable in opposite directions due to mechanical coupling so that the center of their distance does not move during an adjustment. The distance of the support bars 17, 18 this way is adaptable to the format of the respective combination 33 of laminating foil and sheet material to be laminated, so that both side edges of this combination are supported by the support bars 17, 18 during insertion into the pass-through channel 8 and the laminating foil centrally feeds into the pass-through channel.

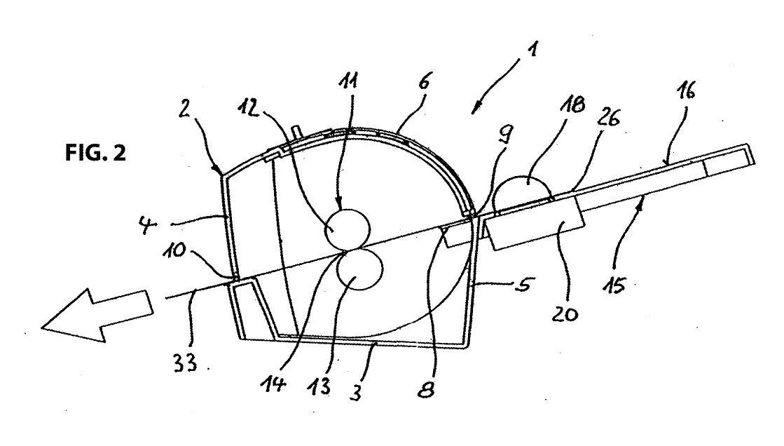

The laminating roller 12 illustrated in FIGS. 3 through 5 separate from the laminator is configured as a hollow roller 20 which includes a metal roller sleeve 21 and a roller cover 22 applied thereto and made from silicon. The roller sleeve is rotatably supported in bearings within the laminating unit 1 that are not illustrated in more detail. At one end, the roller sleeve 21 is connected torque-proof with a radial gear 23. Through the radial gear 23, the laminating roller 12 can be driven in the rotation direction described supra. The other laminating roller 13 (FIG. 2) also includes a radial gear of this type which meshes with the radial gear 23 of the laminating roller 12. The drive is provided through an electric motor.

The hollow roller 20 envelops a cavity 24 that is circular in cross-section into which PTC heating rod 25 protrudes. The PTC heating rod 25 has a rod core 26 made from a material with a positive temperature coefficient (PTC). Advantageously barium-nitrate is used as a base material. The rod core 26 has a rectangular cross-section and is coated at its top side and bottom side with metal electrodes 27, 28 extending over the length of the rod core 26. The metal electrodes are covered with insulating material and provided with electric conductors 29, 30 at a side where the radial gear 23 is arranged in order to supply electrical energy.

The PTC heating rod 25 is supported in the laminating unit 1; this means only the hollow roller 20 is rotated during a laminating process, while the PTC heating rod does not move, thus maintaining its position with reference to the housing 2. The heat transfer between the PTC heating rod 25 and the hollow roller 20 is provided through an air gap there between.

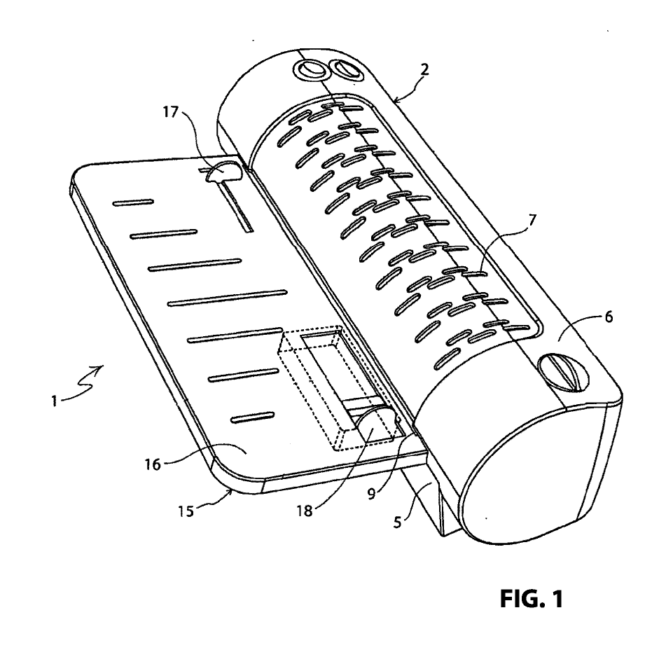

FIGS. 1 through 5 do not illustrate a timing switch which is associated with the electric conductors 29, 30 in the laminator 1. The timing switch includes a first timing element which provides uninterrupted power supply after startup of the laminator 1 during a warm up phase of approximately 4.5 minutes. Thereafter, a second timing element provides a repeated interruption of the power supply for 18 seconds and then a switch on for four seconds.

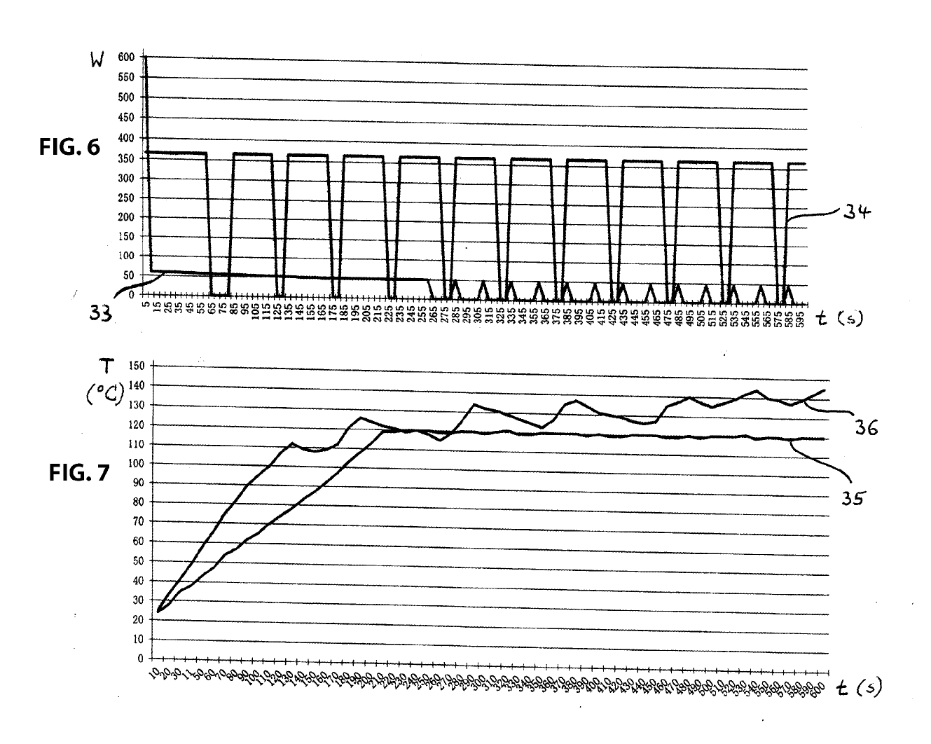

FIG. 6 illustrates the diagram of the energy supply or power supply in Watt (W) over time (t). The power supply diagram for the PTC heating rod 25 is represented by the curve 33. It is evident that after startup of the laminator, the initial power supply of 600 W drops to approximately 50 W within a few seconds and is then interrupted for the first time after 240 seconds. Due to the frequent interruption for 18 seconds and a respective power supply for four seconds, the total energy consumption is significantly below 50 W. Compared thereto, the diagram of power supply for a normal heating rod is represented by the curve 34. It is evident that the interruptions are only short so that a total consumption of 300 W to 400 W is provided.

FIG. 7 illustrates the diagram of the temperature (T) over the time (t) from startup of the laminator 1. The curve 35 represents the temperature diagram of the PTC heating rod 25 according to the invention. It is apparent that the PTC heating rod 25 reaches a nominal temperature of 120° C. after approximately 3.5 minutes and that this nominal temperature remains constant over the illustrated time period with minor variations. The curve 36 which is drawn for comparison purposes represents the temperature diagram of the regular resistive heating rod whose power consumption is illustrated in FIG. 6. Thus, it is apparent that the resistive heating rod heats up quicker, but that the temperature profile has large variations. Furthermore, a tendency is apparent where the average temperature becomes higher and higher; this means that the temperature is in a range of approximately 140° C. after ten minutes. This temperature is too high to continue operations so that a preliminary switch-off has to be provided through an additional overheat protection.

What is claimed is:

1. A laminator for hot laminating sheet material and a laminating foil, comprising: a unit housing through which a pass-through channel extends for passing through a combination of a sheet material and a laminating foil,
wherein at least one laminating unit including a pair of opposite laminating rollers defining a laminating gap is arranged in the pass-through channel;
wherein a heating rod extends along at least one of the pair of opposite laminating rollers;
wherein the heating rod is connected to an electric power supply and configured as a positive temperature coefficient heating rod; and
wherein the positive temperature coefficient heating rod is associated with a timing switch for a power supply which divides the power supply in an alternating manner into time intervals without power being supplied and time intervals with power being supplied.

2. The laminator according to claim 1, wherein the time intervals without power being supplied and the time intervals with power being supplied are constant.

3. The laminator according to claim 2, wherein the time intervals with power being supplied are shorter than the time intervals without power being supplied.

4. The laminator according to claim 3, wherein the length of the time intervals without power being supplied corresponds to at least three times the length of the time intervals with power being supplied.

5. The laminator according to claim 4, wherein the length of time intervals with power being supplied is below 10 seconds.

6. The laminator according to claim 1, wherein the nominal temperature of the laminator is between 110° C. and 130° C., and the lengths of the time intervals with power being supplied and without power being supplied are selected so that a nominal temperature is maintained with a variation of ±2° C.

7. The laminator according claim 1, wherein the timing switch only becomes effective after startup of the laminator and after a heat up phase.

8. The laminator according to claim 7, wherein the heat up phase extends until the nominal temperature has been reached.

9. The laminator according to claim 8, wherein the heat up phase has a length of at least 2 minutes.

10. The laminator according to claim 1, wherein the positive temperature coefficient heating rod extends axially through at least one of the pair of opposite laminating rollers.

11. The laminator according to claim 10,
wherein the positive temperature coefficient heating rod is fixated at the laminator housing, and
wherein the pair of opposite laminating rollers are rotatably supported relative to the positive temperature coefficient heating rod.

12. The laminator according to claim 10, wherein the positive temperature coefficient heating rod is made from ceramic material with barium-nitrate as a base material.

13. The laminator according to claim 10, wherein the positive temperature coefficient heating rod is provided on both sides with flat electrodes extending over a length of the heating rod.

14. The laminator according to claim 10, wherein the positive temperature coefficient heating rod has a distance of 0.5 mm to 1 mm from an inside of an associated laminating roller.

15. The laminator according to claim 1, wherein both of the pair of opposite laminating rollers are provided with positive temperature coefficient heating rods.

16. The laminator according to claim 1, wherein the time intervals with power being supplied are shorter than the time intervals without power being supplied.

17. The laminator according to claim 3, wherein the length of the time intervals without power being supplied corresponds to at least four times the length of the time intervals with power being supplied.

18. The laminator according to claim 4, wherein the length of time intervals with power being supplied is below 5 seconds.

19. The laminator according to claim 6, wherein the nominal temperature of the laminator is between 115° C. and 125° C.

20. The laminator according to claim 19, wherein the nominal temperature of the laminator is 120° C.

21. The laminator according to claim 9, wherein the heat up phase has a length of at least 4 minutes.
